(19) United States
(12) Patent Application Publication
(10) Pub. No.: US 2009/0129287 A1
(43) Pub. Date: May 21, 2009

(54) METHOD, SYSTEM, AND MOBILE NODE FOR UPDATING A CLASSIFIER

(75) Inventors: Wenliang LIANG, Shenzhen (CN); Yong XIE, Shenzhen (CN); Jianjun WU, Shenzhen (CN); Liang GU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/361,197

(22) Filed: Jan. 28, 2009

Related U.S. Application Data
(63) Continuation of application No. PCT/CN2007/070297, filed on Aug. 2, 2007.

(30) Foreign Application Priority Data
Aug. 2, 2006 (CN) 200610106813.4
Nov. 30, 2006 (CN) 200610160850.3

(51) Int. Cl. H04L 12/26

(52) U.S. Cl. 370/252

(57) ABSTRACT

A method, a system, and a mobile node (MN) for updating a data classifier are provided, which mainly include the following steps: acquiring an MN's classifier information before the relocation of an access router and the MN's new classifier information after the relocation of the access router, updating corresponding properties that are changed in the classifier information, and generating updated classifier information. Therefore, after the relocation of the access router, the classifier for data packets can be correctly found, the data packets can be correctly forwarded according to the classifier information, and the uniqueness of the new CoA can be ensured.

### CROSS-REFERENCE TO RELATED APPLICATIONS

This application is a continuation of International Application No. PCT/CN2007/070297, filed Aug. 2, 2007, which claims priority to Chinese Patent Application No. 200610106813.4, filed Aug. 2, 2006 and Chinese Patent Application No. 200610160850.3, filed Nov. 30, 2006, all of which are hereby incorporated by reference in their entirety.

### FIELD OF THE INVENTION

The present invention relates to a field of wireless communication technology, and more particularly to a technology for updating a classifier.

### BACKGROUND

In order to support the Mobile Internet Protocol Version 6 (MIPv6) access of a terminal, the Internet Engineering Task Force (IETF) has defined an IPv6 mobility support document RFC3775 and a relevant security specification document RFC3776. The MIPv6 involves three entities, namely, a mobile node (MN), a home agent (HA), and a correspondent node (CN). An MN in a foreign network has a home address (HoA) and a care-of address (CoA). The MN registers to the HA through a binding update (BU) process, and the HA handles the registration request, and maintains a lookup table between the HoA and the CoA. Then, the HA intercepts a data packet sent to the HoA of the MN in a home network, and forwards the data packet to the CoA of the MN via a tunnel. On the contrary, a data sent from the MN also needs to be sent through the HA via a reverse tunnel.

According to the generating manner, there are two types of CoA, namely, stateful and stateless. A CoA in a stateless manner is generated by a stateless combination of an interface identification (IID) of the MN and a network prefix advertised by an access router (AR). For a unicast address, the IID is generally 64 bits and another 64-bit network prefix is added since the most significant bit of the IID, thereby resulting in a combined 128-bit IPv6 address. As for the stateful manner, a CoA is obtained by means of dynamic host configuration protocol-proxy (DHCP-Proxy) or DHCP-Relay. If the DHCP-Proxy approach is used, the DHCP-Proxy obtains a medium access control (MAC) address of the MN and accomplishes the allocation of the CoA. If the DHCP-Relay approach is used, the DHCP-Relay entity does not obtain the MAC address of the MN, but simply requests the DHCP server for address allocation.

Regardless of the generating manners, it must ensure that the CoA is unique in the range of the current AR. In conventional systems, a duplicate address detection (DAD) process is usually employed to ensure the uniqueness of the CoA. As specified in RFC2462, before an address is allocated to a node, a neighbor solicitation (NS) message must be sent with the address as a target address. After the NS message is sent, if a node attached to the same network has already used the target address in the NS, the node using the address sends a neighbor advertisement (NA), or if a node attached to the same network happens to be attempting to use the target address, a new DAD process is triggered. After the NS message is sent for several times, if no relevant NA/NS has been received within a certain period of time, the address is considered to be unique and can be allocated and used.

The world interoperability for microwave access (WiMAX) technology is a wireless access technology. In a WiMAX network, if each MN sends an NS message to all the terminals with the same network prefix when performing the NS, the occupation of wireless resources is intolerable. Therefore, an AR is taken as the sole neighbor for all the MNs, so that the AR receives the NS messages sent from all the MNs and thereby knows all the addresses being used in the current network segment. As such, the AR is able to determine the uniqueness of a target address.

In the WiMAX network, a classifier is adapted to classify various services carried by a network into specific service flows of a carrier network based on different Quality of Service (QoS) requirements of upper services. The service flow is the minimum operation object for the QoS guarantee of the WiMAX carrier network, and different service flows have different QoS guarantees. The classifier is formed by a series of classification rules, and the specific classification parameters thereof can be found with reference to IEEE802.16d/e. In an IP network, one of the main parameters of a classifier is source/destination IP address. A classifier for an uplink service is implemented on the MN, and a classifier for a downlink service is implemented on a base station (BS) or a gateway (GW).

In the WiMAX network, due to the mobility of the MN or optimization of network resources, the AR of the MN may be relocated, i.e., an AR is switched to another AR, and meanwhile, the network prefix and the CoA of a mobile station (MS) are updated accordingly. Before the relocation, an access service network gate way (ASN-GW) notifies the current classifier information to a new ASN-GW after the relocation, i.e., a target ASN-GW. However, the classifier information after the relocation of the AR is not updated correspondingly. That is, after the relocation of the AR, a destination address of a data packet is the new CoA, but the classifier information of the new ASN-GW after the relocation is still based on the original CoA.

As described above, the classifier information carried by the target ASN-GW after the relocation of the AR is still based on the original CoA, and it is possible that a correct classifier cannot be found according to the destination address of the arrived downlink data packet, so that the downlink data packet cannot be forwarded correctly.

### SUMMARY

In an embodiment, the present invention is directed to a method for updating a classifier, a system for updating a classifier, and a corresponding mobile node (MN), in which a network side is enabled to find out a classifier for a data packet correctly when a router is relocated.

In an embodiment, the present invention provides a method for updating a classifier, which includes (1) classifier information of an MN before a relocation of an access router (AR) is acquired; (2) classifier updating information of the MN after the relocation of the AR is acquired; and (3) a portion that is changed with the relocation of the AR in the classifier information before the relocation is updated by the classifier updating information so as to get updated classifier information.

In another embodiment, the present invention also provides a method for updating a classifier, which includes, if an AR of an MN is relocated, (1) a serving ASN-GW of the MN acquires a network prefix advertised by a target ASN-GW of the MN; (2) the serving ASN-GW replaces a network prefix in classifier information of the serving ASN-GW itself corresponding to the MN and/or a network prefix of a target address with the acquired network prefix so as to get updated classifier information; and (3) the serving ASN-GW sends the updated classifier information to the target ASN-GW.

In another embodiment, the present invention also provides a method for updating a classifier, which includes: if an AR of an MN is relocated, (1) a serving ASN-GW of the MN sends classifier information of the MN to a target ASN-GW of the MN; and (2) the target ASN-GW replaces a network prefix in the classifier information and/or a network prefix of a target address with a network prefix advertised by the target ASN-GW itself so as to get updated classifier information.

In another embodiment, the present invention further provides a method for updating a classifier, which includes, if an AR of an MN is relocated, (1) the MN receives an advertisement from a target ASN-GW of the MN and obtains classifier updating information according to the advertisement; (2) the MN notifies the classifier updating information to a network side; and (3) the network side updates a classifier according to the received classifier updating information.

In an embodiment, the present invention further provides a method for updating a classifier, which includes, if an AR of an MN is relocated, (1) the MN acquires a classifier updating information, and (2) the MN replaces a portion that is changed with the relocation of the AR in an uplink data classifier of the MN by the classifier updating information so as to generate an updated classifier.

In an embodiment, the present invention further provides a system for updating a classifier, which includes (1) a device, adapted to acquire classifier information of the MN before a relocation of an AR; (2) a device, adapted to acquire classifier updating information of the MN after the relocation of the AR; and (3) a device, adapted to replace the classifier information with the classifier updating information.

In an embodiment, the present invention provides a mobile communication system, which includes an ASN-GW, an MN, and a BS, and further includes a classifier management module, adapted to save classifier information of the MN, acquire classifier updating information of the MN after a relocation of an AR, and update the classifier information of the MN according to the classifier updating information.

In an embodiment, the present invention provides an MN, which includes a classifier information acquisition module and a classifier updating module. The classifier information acquisition module is adapted to acquire classifier updating information of the MN when an AR of the MN is relocated, and notify the classifier updating information to the classifier updating module. The classifier updating module is adapted to update an uplink data classifier of MN according to the classifier updating information.

In view of the above technical solutions, in the method of the present invention, classifier updating information after the relocation of the AR is acquired in a certain manner, and a portion that is changed with the relocation of the AR in the classifier information before the relocation is updated by the classifier updating information. Thus, the classifier for a data packet can be found out correctly after the relocation of the AR and the data packet can be forwarded correctly according to the classifier information. Furthermore, by implementing the solutions of the present invention, a DAD process can be performed in advance and the DAD delay can be shortened.

### BRIEF DESCRIPTION OF THE DRAWINGS

FIG. 1 is a schematic view of a system connection according to a first embodiment of the present invention;

FIG. 2 is a flow chart of a processing procedure according to the first embodiment of the present invention;

FIG. 3 is a schematic view of a system connection according to a second embodiment of the present invention;

FIG. 4 is a flow chart of a processing procedure according to the second embodiment of the present invention;

FIG. 5 is a schematic view of a system connection according to a third embodiment of the present invention;

FIG. 6 is a flow chart of a processing procedure according to the third embodiment of the present invention;

FIG. 7 is a schematic view of a system connection according to a fourth embodiment of the present invention;

FIG. 8 is a flow chart of a processing procedure according to the fourth embodiment of the present invention;

FIG. 9 is a flow chart of a processing procedure according to a sixth embodiment of the present invention; and

FIG. 10 is a flow chart of a processing procedure according to a seventh embodiment of the present invention.

### DETAILED DESCRIPTION

The present invention is described in detail hereinafter with reference to the accompanying drawings.

In an embodiment of the present invention, a classifier is updated by acquiring classifier updating information of an MN after a relocation of an AR and updating the classifier information before the relocation of the AR according to the classifier updating information. The classifier updating information includes, but not limited to, a protocol type, a source address, a destination address, a source port number, a destination port number, a flow identifier, next header information, another IP header information, and header compression information. In the system according to an embodiment of the present invention, once a certain network element acquires the classifier updating information, the network element updates a classifier of the network element itself and notifies relevant network elements to update their classifiers, or sends the classifier updating information to a relevant network element for making classifier update. The network elements may be an MN, a BS, an ASN-GW, and the like.

The classifier includes a downlink classifier and an uplink classifier. The classifier update mentioned in an embodiment of the present invention refers to an update of a network prefix and/or a destination address as for a downlink classifier and refers to an update of a source address and/or a network prefix as for an uplink classifier.

The update of downlink classifier information mainly includes updating the network prefix property in the classifier information and/or establishing a corresponding relation between the original CoA before the relocation of the AR and the new CoA after the relocation of the AR, and ensuring the uniqueness of the new CoA. No matter the new CoA of the MN is generated in a stateful manner or a stateless manner, corresponding classifier information on a network side should be correspondingly updated according to the new CoA after the relocation of the AR. That is, after the relocation of the AR, a destination address of a downlink data packet is the new CoA of the MN and the classifier information on the network side is also based on the new CoA of the MN. In this way, the network side can find out the classifier for the downlink data packet correctly and forward the downlink data packet correctly after the relocation of the AR. An embodiment of the present invention is applied in the MIPv6 network environment and the main parameters of the classifier include source/destination IP address, a protocol type, source/destination port number, and a network prefix may also be considered as a classifier parameter.

The updating process of a downlink classifier has been explained through, for example, the following seven embodiments.

### EMBODIMENT 1

### Update of Downlink Classifier Information Based on a DAD Process

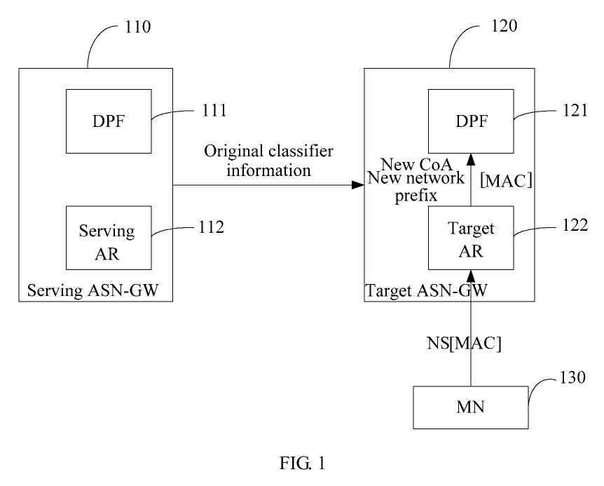

This embodiment is applicable to both a CoA generated in a stateless manner and a CoA generated in a stateful manner. A lookup table for an MN identifier and the classifier information is required to be maintained in an ASN-GW. In this embodiment, an MAC address or an IID of the MN is used as the MN identifier. FIG. 1 is a schematic view of a system connection according to an embodiment of the present invention. A serving ASN-GW 110 includes a data path function (DPF) entity 111 and a serving AR 112, and a target ASN-GW 120 includes a DPF 121 and a target AR 122.

The target AR 122 is adapted to send a router advertisement containing a network prefix. The target AR 122 is also adapted to receive an NS carrying a MAC address and a new CoA from an MN 130, search locally to find out whether a repeatedly registered address exists or not according to the received new CoA, and send the MAC address and the new CoA to the DPF 121 according to the searching result.

The DPF 121 is adapted to receive classifier information from the serving ASN-GW 110, receive the MAC address and the new CoA from the target AR 122, search for classifier information containing the same MAC address according to the received MAC address, replace a destination address in the searched classifier information with the new CoA so as to get an updated classifier, and the DPF 121 is further adapted to update the original classifier information with the newly-obtained network prefix.

In an embodiment of the present invention, the DPF serves as a functional entity for managing a classifier, which is only taken as an example. In practical applications, the classifier management function may also be achieved by other modules in the ASN-GW. Therefore, the classifier management module is not restricted to the DPF, but may be implemented by any other module as long as the ASN-GW includes such a classifier management module capable of achieving the above functions.

The MN 130 is adapted to receive the router advertisement from the target AR 122, generate a new CoA in a stateless manner according to the network prefix in the router advertisement and the IID of the MN 130 itself, and send an NS carrying the MAC address and the new CoA to the target ASN-GW 120. The IID may be calculated from the MAC address.

The serving ASN-GW 110 is adapted to send the classifier information based on the CoA of the MN before the relocation of the AR to the target ASN-GW. The information may be sent by the serving AR 112 or the DPF 111 or other modules in the serving ASN-GW 110, which is not limited in the present invention.

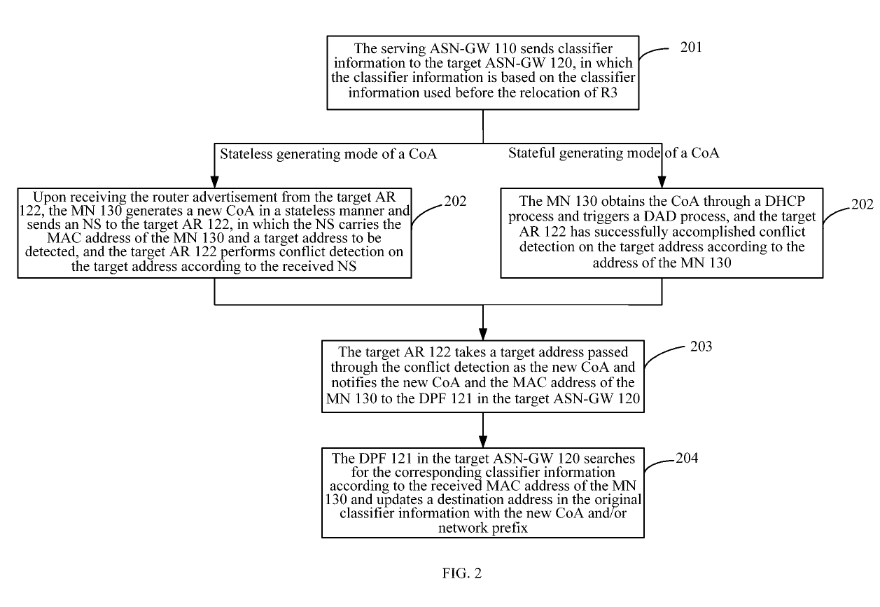

The updating process of the downlink classifier information according to the first embodiment is shown in FIG. 2, which includes the following steps.

In Step 201, when the AR is relocated, the serving ASN-GW 110 sends classifier information to the target ASN-GW 120, in which the classifier information is based on the CoA and/or network prefix used before the relocation of the AR.

In Step 202, this step includes two circumstances depending on the generating manner of the CoA.

In a stateless generating mode of a CoA, after receiving the router advertisement from the target AR 122, the MN 130 generates a new CoA in a stateless manner according to a network prefix in the router advertisement and the IID of the MN 130 itself, and then sends an NS to the target AR 122, in which the NS carries the MAC address of the MN 130 and a target address to be detected. The IID may be calculated from the MAC address. The target AR 122 performs conflict detection on the target address according to the received NS. If no conflict is detected, it proceeds to Step 203. The so-called conflict detection includes comparing the target address in the NS with CoAes of all the current MNs registered to the target AR 122, and if there are no identical addresses, no conflict exists; otherwise, an address conflict occurs.

In a stateful generating mode of a CoA, the MN 130 obtains the CoA through a DHCP process and triggers a DAD process. After the target AR 122 has successfully accomplished conflict detection on the target address according to the address of the MN 130, it proceeds to Step 203.

In Step 203, the target AR 122 takes a target address passed through the conflict detection as the new CoA and notifies the new CoA and the MAC address of the MN 130 to the DPF 121 in the target ASN-GW 120. The new CoA contains new network prefix information.

In Step 204, the DPF 121 in the target ASN-GW 120 searches for classifier information with the same MAC address according to the received MAC address of the MN 130 and updates a destination address and/or a network prefix in the searched classifier information with the new CoA and/or network prefix, thereby generating updated classifier information. The updating process of the classifier information may further include using a random mask to the destination address and/or network prefix.

Any external function achieved by the above DPF or AR as functional modules in the ASN-GW may be considered as the function achieved by the ASN-GW itself. Accordingly, the ASN-GW is considered as the subject for implementing such external functions below.

### EMBODIMENT 2

### Update of the Downlink Classifier Information Based on the MAC address

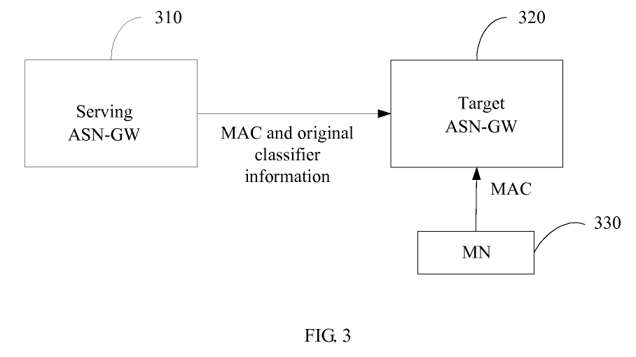

In this embodiment, the following premises should be satisfied. That is, the CoA is generated in a stateless manner according to the IID of the MN and the IID of the MN is generated from the MAC address according to RFC2464. FIG. 3 is a schematic view of a system connection according to an embodiment of the present invention. Each of the components and connections there-between are described as follows.

A serving ASN-GW 310 is adapted to send classifier information to a target ASN-GW, in which the classifier information is based on a CoA of an MN before a relocation of an AR. The serving ASN-GW 310 is further adapted to send a MAC address of an MN 330 to the target ASN-GW 320.

The target ASN-GW 320 is adapted to send a router advertisement containing a network prefix, maintain the classifier information, acquire the MAC address of the MN 330 from the serving ASN-GW 310 or the MN 330, generate an IID of the MN 330 based on the acquired MAC address, and generate a new CoA according to the IID and the network prefix advertised by the target ASN-GW 320 itself. The target ASN-GW 320 is further adapted to receive the classifier information from the serving ASN-GW 310 and replace a destination address in the classifier information with the newly generated CoA so as to get an updated downlink classifier. The target ASN-GW 320 further includes an address conflict detection module adapted to perform conflict detection on the new CoA. If an address conflict is detected, any of the following processing manners may be selected.

The target ASN-GW 320 notifies the address conflict to the MN 330.

The target ASN-GW 320 regenerates a CoA or an IID.

The MN 330 is adapted to send its MAC address to the target ASN-GW 320.

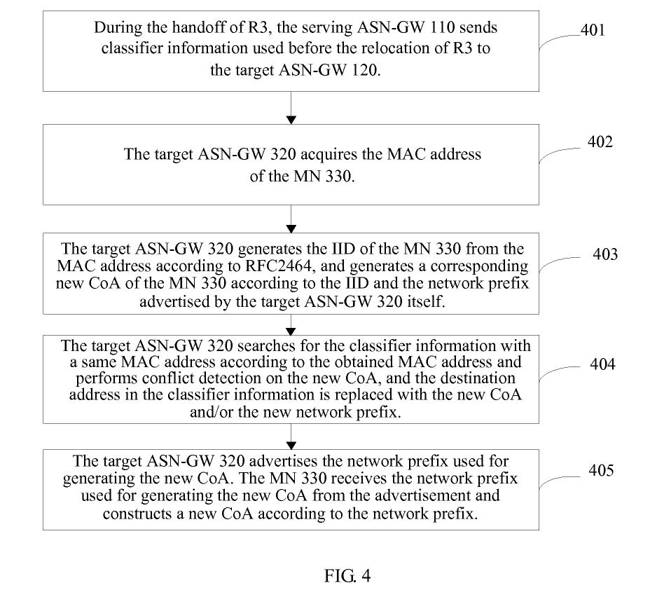

The updating process of the downlink classifier information according to the embodiment of the present invention is shown in FIG. 4, which includes the following steps.

In Step 401, when the AR is relocated, the serving ASN-GW 310 sends classifier information to the target ASN-GW 320, in which the classifier information is based on the CoA and the network prefix used before the relocation of the AR.

In Step 402, the target ASN-GW 320 obtains the MAC address of the MN 330 through one of the following manners.

(1) When the AR is relocated, the serving ASN-GW 310 notifies the MAC address of the MN 330 to the target ASN-GW 320.

(2) When the MN 330 accesses the network again, the target ASN-GW 320 obtains the MAC address from the MN 330.

In Step 403, the target ASN-GW 320 generates the IID of the MN 330 from the MAC address according to RFC2464. The target ASN-GW 320 generates a corresponding new CoA of the MN 330 according to the IID and the network prefix advertised by the target ASN-GW 320 itself.

In Step 404, the target ASN-GW 320 is adapted to search for classifier information with the same MAC address according to the obtained MAC address, and perform conflict detection on the new CoA first. If no conflict is detected, a destination address in the classifier information is replaced with the new CoA, and the process proceeds to Step 405. If an address conflict is detected, any of the following processing manners may be selected.

The target ASN-GW 320 notifies the address conflict to the current MN 330 and terminates the current flow.

The target ASN-GW 320 regenerates a new CoA/IID and Step 404 is performed once again.

The MN 330 generates a CoA/IID by itself and Step 404 is performed once again.

In Step 405, the target ASN-GW 320 advertises the network prefix used for generating the new CoA. The MN 330 receives the network prefix used for generating the new CoA from the advertisement and constructs a new CoA according to the network prefix.

If the new CoA is a CoA regenerated after the conflict, the target ASN-GW 320 also needs to notify the MN 330 to use the new CoA, thereby ensuring the consistency between the target address in the classifier information maintained in the target ASN-GW 320 and the CoA actually obtained by the MN 330.

### EMBODIMENT 3

### The AR Carries an IID During the Relocation

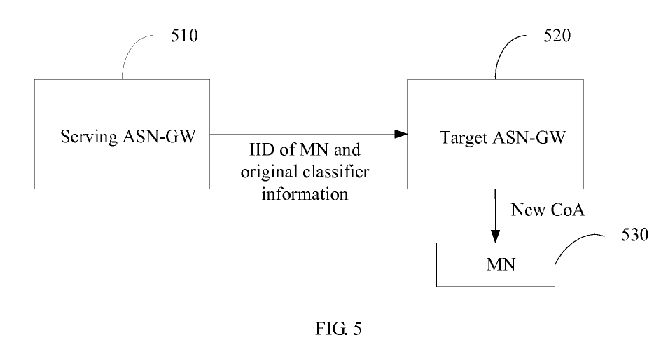

In this embodiment, the following premises should be satisfied. That is, a CoA is generated in a stateless manner, and an IID of an MN remains constant during the relocation process of the AR. FIG. 5 is a schematic view of a system connection according to a third embodiment of the present invention. Each of the components and the connections there-between are described as follows.

A serving ASN-GW 510 is adapted to send classifier information to a target ASN-GW 520, in which the classifier information is based on a CoA of an MN 530 before a relocation of an AR. The serving ASN-GW 510 is further adapted to send an IID of the MN 530 to the target ASN-GW 520.

The target ASN-GW 520 is adapted to send a router advertisement containing a network prefix, maintain classifier information, generate a new CoA of the MN 530 according to the received IID and the network prefix advertised by the target ASN-GW 520 itself, replace a destination address in the classifier information from the serving ASN-GW 510 with the new CoA to obtain an updated downlink classifier, and notify the new CoA to the MN 530.

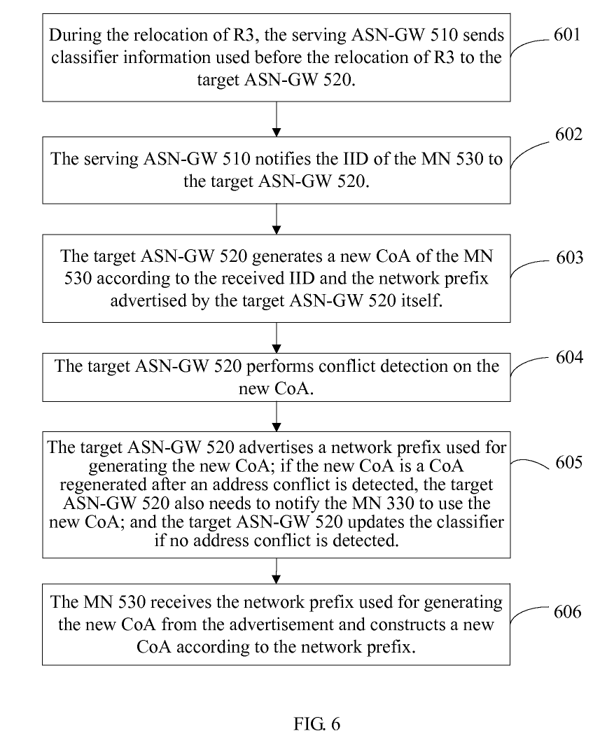

The updating process of the downlink classifier information according to this embodiment is shown in FIG. 6, which includes the following steps.

In Step 601, when the AR is relocated, the serving ASN-GW 510 sends classifier information to the target ASN-GW 520, in which the classifier information is based on the CoA used before the relocation of the AR.

In Step 602, the serving ASN-GW 510 notifies the IID of the MN 530 to the target ASN-GW 520.

In Step 603, the target ASN-GW 520 generates a new CoA of the MN 530 according to the received IID and the network prefix advertised by the target ASN-GW 520 itself.

In Step 604, the target ASN-GW 520 performs conflict detection on the new CoA. If no address conflict is detected, the process proceeds to Step 605. If an address conflict is detected, any of the following processing manners may be selected.

The target ASN-GW 520 notifies the address conflict to the MN 530 and terminates the current flow.

The target ASN-GW 520 regenerates a new CoA/IID and Step 604 is performed once again.

The MN 530 generates a CoA/IID by itself and Step 604 is performed once again.

In Step 605, the target ASN-GW 520 advertises a network prefix used for generating the new CoA. If the new CoA is a CoA regenerated after an address conflict is detected, the target ASN-GW 520 also needs to notify the MN 330 to use the new CoA.

In Step 606, the MN 530 receives the network prefix used for generating the new CoA from the advertisement and constructs a new CoA according to the network prefix.

### EMBODIMENT 4

### The Target Address Information in the Classifier Information is Directly Replaced so as to Get an Updated Classifier

The flow of this embodiment is described as follows. When an AR of an MN is relocated, a serving ASN-GW sends classifier information to a target ASN-GW, in which the classifier information is based on a CoA and/or network prefix used before the relocation of the AR.

After the relocation of the AR, the target ASN-GW calculates a new CoA of the MN according to the network prefix currently allocated to the MN and the IID of the MN. Then, the target ASN-GW replaces a destination address in the received classifier information with the new CoA, and/or replaces a network prefix in the original classifier information with the new network prefix.

Alternatively, the flow of this embodiment is described as follows.

The serving ASN-GW obtains an address prefix allocated to the MN by the target ASN-GW and the IID of the MN and calculates a new CoA of the MN according to the network prefix and the IID.

The serving ASN-GW replaces a destination address in the classifier information with the new CoA, and/or replaces a network prefix in the original classifier information with the new network prefix so as to get updated classifier information.

The serving ASN-GW sends the updated classifier information to the target ASN-GW.

Ensuring the uniqueness of the new CoA refers to ensuring the uniqueness of the combination of the network prefix and the IID. In practical applications, it only needs to ensure that either the network prefix or the IID is unique in the range of the MNs connected to the target ASN-GW. That is, one of the following conditions needs to be satisfied.

A. The uniqueness of the IID is ensured. The IID of the MN may remain constant during the relocation process of the AR. In this case, the target ASN-GW needs to check whether the IID is unique or not, and if yes, the IID remains constant; otherwise, the ASN-GW reallocates a unique IID to the MN. Alternatively, each time after the AR is relocated, the target ASN-GW allocates a new and unique IID to the MN.

B. The uniqueness of the network prefix is ensured. The target ASN-GW allocates a unique network prefix to the MN.

If condition a is satisfied, the target ASN-GW may allocate a network prefix shared by all the MNs under the ASN-GW to the MN.

If condition b is satisfied, the target ASN-GW may allocate a repeated IID to the MN.

### EMBODIMENT 5

### A New CoA is Obtained According to a Data Packet in the Initial Service Flow (ISF)

This embodiment can be applied in the following scenario: the CoA is generated in a stateless manner and the IID of the MS remains constant during the relocation of the AR.

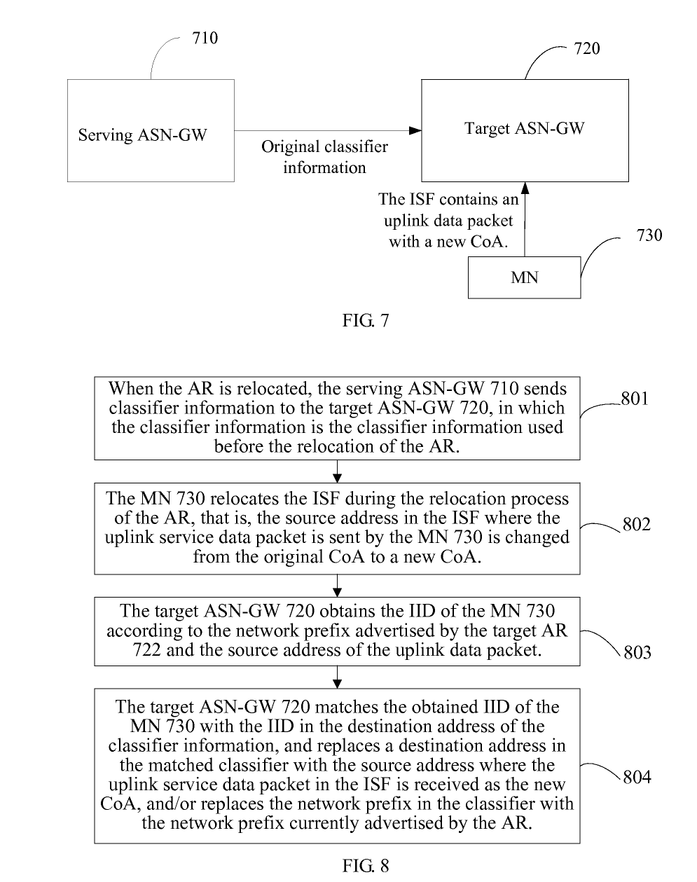

FIG. 7 is a schematic view of a system connection according to a fifth embodiment of the present invention. Each of the components and the connections there-between are described as follows.

A serving ASN-GW 710 is adapted to send classifier information to a target ASN-GW 720, in which the classifier information is based on a CoA of an MN 730 before a relocation of an AR.

The target ASN-GW 720 is adapted to send a router advertisement containing a network prefix, maintain the classifier information, obtain an IID of the MN 730 according to the network prefix advertised by the target ASN-GW 720 itself and a source address of an uplink data packet in the ISF, match the obtained IID of the MN 730 with an IID of a destination address in the maintained classifier information, obtain a new CoA according to the source address of the uplink service data packet in the ISF, replace a destination address in the matched classifier with the new CoA, thereby getting an updated classifier.

In the case that one MN uses only one CoA, a source address of the data packet in the ISF is analyzed according to the corresponding relation between the ISF and the MAC address of the MN, in which a multicast advertisement address and a local address are removed from the source address, thereby resulting in a new CoA of the MN. The multicast advertisement address is a special IP address, which may not contain the IID and the network prefix advertised by the target ASN-GW. The local address is constituted by a fixed and non-global-routable local network prefix plus the IID.

The updating process of the downlink classifier information according to this embodiment is shown in FIG. 8, which includes the following steps.

In Step 801, when the AR is relocated, the serving ASN-GW 710 sends classifier information to the target ASN-GW 720, in which the classifier information is based on the CoA used before the relocation of the AR.

In Step 802, the MN 730 relocates the ISF during the relocation process of the AR. That is, the source address in the ISF where the uplink service data packet is sent by the MN 730 is changed from the original CoA to a new CoA. The so-called ISF is a data channel adapted to transmit high level signaling in an initial phase of the MN access. The relocation process of the ISF is based on the descriptions about the existing standards, which does not fall within the scope of the present invention.

In Step 803, the target ASN-GW 720 obtains the IID of the MN 730 according to the network prefix advertised by the target AR 722 and the source address of the uplink data packet.

In Step 804, the target ASN-GW 720 matches the obtained IID of the MN 730 with the IID in the destination address of the classifier information, and replaces a destination address in the matched classifier with the source address where the uplink service data packet in the ISF is received as the new CoA.

In the case that one MN uses only one CoA, Steps 803 and 804 can be combined. That is, the source address of the data packet in the ISF is analyzed according to the corresponding relations between the ISF and the MAC address of the MN, in which a multicast advertisement address and a local address are removed from the source address, thereby resulting in a new CoA of the MN. A destination address in the matched classifier is replaced with the new CoA, thereby getting an updated classifier.

### EMBODIMENT 6

### The Classifier is Implemented in a BS

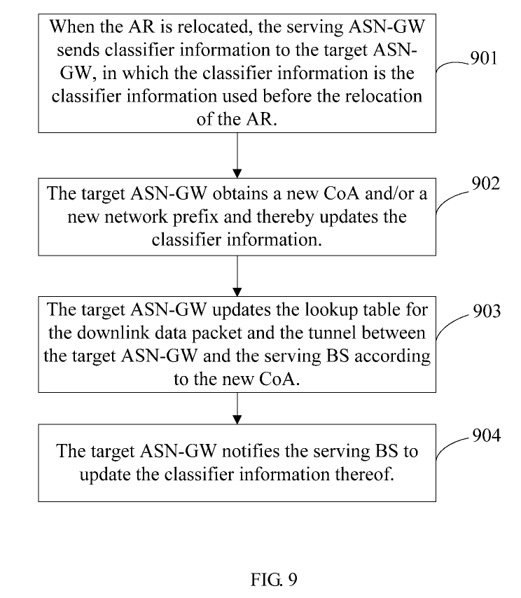

The above first to fifth embodiments are all based on the circumstance that the classifier is located in the ASN-GW. In practical applications, the ASN-GW may not save the classifier information by itself, but save the classifier information in a serving BS. That is, the ASN-GW may not include the classifier management module, but the serving BS is provided with a classifier management module. In this embodiment, the ASN-GW needs to place a downlink data packet in a tunnel between the ASN-GW and the serving BS, which is typically accomplished by a lookup table for the downlink data packet and the tunnel. The implementation flow of this embodiment is shown in FIG. 9, which includes the following steps.

In Step 901, when the AR is relocated, the serving ASN-GW sends classifier information to the target ASN-GW, in which the classifier information is the classifier information used before the relocation of the AR.

In Step 902, the target ASN-GW obtains a new CoA and then gets an updated classifier through any of the implementation manners mentioned in the above first to fifth embodiments.

In Step 903, the target ASN-GW updates the lookup table for the downlink data packet and the tunnel between the target ASN-GW and the serving BS according to the new CoA.

In Step 904, the target ASN-GW searches for a corresponding tunnel according to the lookup table and updates the classifier information on the serving BS via the tunnel, that is, changes a destination address in the classifier information on the serving BS from the original CoA to a new CoA, and/or replaces a network prefix in the original classifier information with a new network prefix, which may be accomplished through a resource reservation (RR) process or other processes for achieving similar functions. Any of the following specific approaches may be selected.

The target ASN-GW delivers classifier information based on the original CoA to the BS and then delivers a new CoA and/or network prefix to the BS, so that the BS updates the current classifier information by using the new CoA and/or network prefix.

The target ASN-GW replaces a destination address in the classifier information with the new CoA to get classifier information based on the new CoA and/or replaces a network prefix in the original classifier information with the new network prefix, and then sends the updated classifier information to the BS.

### EMBODIMENT 7

### MN Initiates to Update the Classifier Information

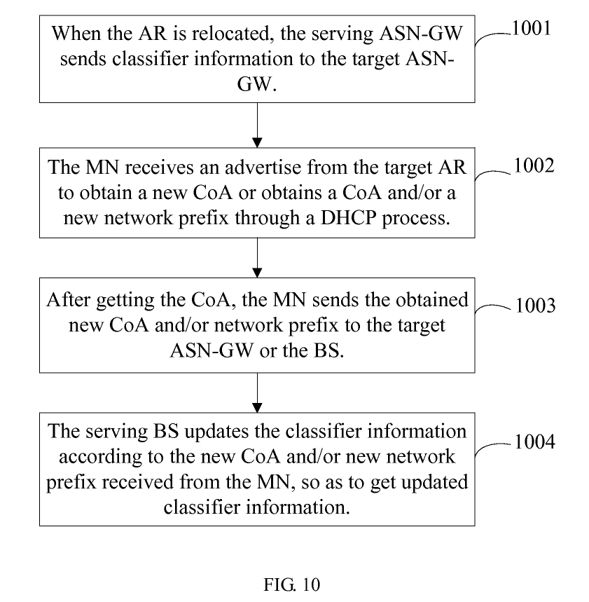

This embodiment is applicable to the circumstances that a CoA is generated in a stateless manner or in a stateful manner and that the classifier is located on the ASN-GW or the BS. The MN is provided with a classifier updating initiation module adapted to generate a new CoA and/or obtain a new network prefix and send the new CoA and/or network prefix of the MN to the BS. The classifier management module in the BS updates a classifier according to the new CoA and/or the new network prefix. Alternatively, the BS sends the new CoA and/or the new network prefix to the classifier management module in the ASN-GW and the ASN-GW updates the classifier. The flow of this embodiment is shown in FIG. 10, which includes the following steps.

In Step 1001, when the AR is relocated, the serving ASN-GW sends classifier information to the target ASN-GW, in which the classifier information is based on the CoA and/or the original network prefix used before the relocation of the AR.

In Step 1002, in the case that a CoA is generated in a stateless manner, the MN receives an advertisement from the target ASN-GW to obtain a new CoA.

Alternatively, in the case that a CoA is generated in a stateful manner, the CoA is directly obtained or constructed through a DHCP process.

Step 1002 can ensure the uniqueness of the new CoA through any of the following manners.

A. The uniqueness of the new CoA is ensured through a DAD process.

B. The ASN-GW allocates a network prefix uniquely corresponding to the MN so as to ensure the uniqueness of the new CoA.

C. The network allocates an IID uniquely corresponding to the MN so as to ensure the uniqueness of the CoA.

D. The network directly allocates a unique IP address as the new CoA so as to ensure the uniqueness of the CoA.

In Step 1003, after getting the CoA, the MN sends the obtained new CoA and/or network prefix to the target ASN-GW or the BS. Particularly, the MN may send a dynamic service change (DSC) message carrying the new CoA and/or the new network prefix.

In Step 1004, the serving BS updates a destination address in the classifier information according to the new CoA and/or new network prefix received from the MN so as to get the updated classifier information.

The above step may also be implemented in another way, that is, the serving BS notifies the new CoA and/or new network prefix carried in the received DSC request message to the target ASN-GW, and the target ASN-GW updates the destination address in the classifier information according to the received new CoA and/or new network prefix so as to get updated classifier information.

### EMBODIMENT 8

### Update of the Uplink Data Classifier Information

The updating process of the uplink data classifier is always accomplished at the MN and the MN knows a new CoA and/or new network prefix after the relocation of the AR. After the MN has obtained the new CoA and/or the new network prefix and before the binding update (BU)/binding answer (BA) process, the MN replaces the source address in the uplink data classifier with the new CoA.

The MN includes a CoA acquisition module and a classifier updating module. The classifier information acquisition module is adapted to acquire a new CoA and/or new network prefix of the MN and notifies the new CoA and/or new network prefix to the classifier updating module. The new CoA may be acquired through such a manner that the MN receives an advertisement from a network side and generates a new CoA according to the network prefix in the advertisement.

Alternatively, the MN receives a DSC request carrying a new CoA of the MN from the network side.

Alternatively, the MN gets a new IP address through the DHCP process and uses the new IP address as a new CoA.

The classifier updating module is adapted to replace a source address in the uplink data classifier of the MN with the new CoA and/or replace the original network prefix in the classifier information with the new network prefix when updating the classifier.

The process of triggering an update of the uplink data classifier information through the network side may also be employed, which includes the following two steps.

When the AR is relocated, the network side updates classifier information, that is, takes the new CoA of the MN as a destination address of the classifier, which may be accomplished through any of the approaches mentioned in the above first to eighth embodiments.

The network side triggers the BS to initiate the DSC process, that is, sends a DSC message to the MN, in which the DSC message carries the new CoA and/or new network prefix of the MN. The MN updates the source address in the uplink data classifier information of the MN with the new CoA carried in the received DSC message and/or replaces the original network prefix in the classifier information with the new network prefix so as to get updated uplink data classifier information.

The above embodiments are merely intended to describe the technical solutions of the present invention, but not to limit the scope of present invention. It will be apparent to those skilled in the art that various modifications and variations can be made to the structure of the present invention without departing from the scope or spirit of the invention.

What is claimed is:

1. A method for updating a classifier, comprising:
acquiring classifier information of a mobile node (MN) before a relocation of an access router (AR);
acquiring classifier updating information of the MN after the relocation of the AR; and
updating a portion of the classifier information with the classifier updating information for generating updated classifier information, wherein the portion of the classifier information is associated with the relocation of the AR.

2. The method according to claim 1, wherein the acquiring the classifier updating information of the MN after the relocation of the AR comprises one of:
acquiring, by a target access service network gate way (ASN-GW), a network prefix of the MN and an interface identifier (IID) of the MN and obtaining a care-of address (CoA) after the relocation according to the network prefix and the IID;
obtaining, by the target ASN-GW, the CoA of the MN after the relocation through a duplicate address detection (DAD) process; and
obtaining, by the target ASN-GW, the CoA of the MN after the relocation by resolving a source address in a data packet in an initial service flow sent by the MN.

3. The method according to claim 2, wherein the network prefix of the CoA comprises one of:
taking, by the target ASN-GW, a network prefix that is advertised currently as the network prefix for generating the CoA after the relocation; and
allocating, by the target ASN-GW, a network prefix uniquely corresponding to the MN and taking the allocated network prefix as the network prefix for generating the CoA after the relocation.

4. The method according to claim 2, wherein the acquiring, by the target ASN-GW, the IID of the MN comprises one of:
acquiring, by the target ASN-GW, a media access control (MAC) address of the MN and generating the IID of the MN according to the MAC address;
receiving, by the target ASN-GW, the IID of the MN from a serving ASN-GW;
allocating, by the target ASN-GW, the IID corresponding to the MN; and
acquiring, by the target ASN-GW, the IID in original classifier information.

5. The method according to claim 2, wherein after the acquiring, by the target ASN-GW, the CoA of the MN after the relocation, the method further comprises at least one of:
performing the DAD process on the CoA after the relocation; and
advertising, by the target ASN-GW, the network prefix for generating the CoA after the relocation.

6. The method according to claim 2, wherein the updating a portion of the classifier information with the classifier updating information for generating updated classifier information comprises:
searching, by the target ASN-GW, for classifier information containing the same MAC address as the MN according to the MAC address of the MN;
and further comprises at least one of:
replacing a destination address in the searched classifier information with the CoA after the relocation; and
replacing a network prefix in the searched classifier information with the acquired network prefix of the CoA.

7. The method according to claim 1, wherein the updating a portion of the classifier information with the classifier updating information for generating updated classifier information comprises one of:
updating, by a target ASN-GW, the portion of the classifier information acquired by the target ASN-GW with the classifier updating information so as to get the updated classifier information in the target ASN-GW; and
delivering, by the target ASN-GW, the classifier information and the classifier updating information to a serving base station (BS), and updating, by the serving BS, the portion of the classifier information by the classifier updating information so as to get the updated classifier information in the serving BS.

8. The method according to claim 7, wherein after getting the updated classifier information in the target ASN-GW, the method further comprises:
delivering, by the target ASN-GW, the updated classifier information to the serving BS.

9. A method for updating a classifier, comprising:
acquiring, by a serving access service network gate way (ASN-GW) of a mobile node MN, a network prefix advertised by a target ASN-GW of the MN;
replacing, by the serving ASN-GW, at least one of a network prefix in classifier information of the serving ASN-GW corresponding to the MN and a network prefix of a target address in the classifier information with the acquired network prefix so as to get updated classifier information; and
sending, by the serving ASN-GW, the updated classifier information to the target ASN-GW.

10. A method for updating a classifier, comprising:
sending, by a serving access service network gate way (ASN-GW) of the MN, classifier information of the MN to a target ASN-GW of the MN; and
replacing, by the target ASN-GW, at least one of a network prefix in the classifier information and a network prefix of a target address in the classifier information with a network prefix advertised by the target ASN-GW to get updated classifier information.

11. A method for updating a classifier, comprising:
receiving, by a mobile node (MN), an advertisement from a target access service network gate way (ASN-GW) of the MN and obtaining classifier updating information according to the advertisement;
notifying, by the MN, the classifier updating information to a network side; and
updating, by the network side, the classifier according to the classifier updating information.

12. The method according to claim 11, wherein the updating, by the network side, the classifier according to the classifier updating information comprises at least one of:
replacing, by one of a serving BS and a target ASN-GW of the MN, a target address in a classifier of one of the serving BS and a target ASN-GW itself with a care-of address (CoA) after the relocation in the received classifier updating information to get the updated classifier information; and
replacing, by one of the serving BS and the target ASN-GW of the MN, a network prefix in a classifier of one of the serving BS and the target ASN-GW itself with a new network prefix in the received classifier updating information so as to get the updated classifier information.

13. A method for updating a classifier, comprising:
acquiring, by a mobile node (MN), classifier updating information;
replacing, by the MN, a portion in an uplink data classifier of the MN with the classifier updating information to generate an updated classifier, wherein the portion in the uplink data classifier of the MN is associated with the relocation of the AR.

14. The method according to claim 13, wherein the acquiring, by the MN, classifier updating information comprises one of:
receiving, by the MN, an advertisement from a network side and generating a care-of address (CoA) after the relocation according to a network prefix in the advertisement;
receiving, by the MN, a dynamic service change (DSC) request from the network side carrying at least one of a CoA and a network prefix of the MN after the relocation;
obtaining, by the MN, a network prefix allocated by a target network through a dynamic host configuration protocol (DHCP) process and configuring a CoA after the relocation;
obtaining, by the MN, a new IP address through the DHCP process, and taking the new IP address as the CoA after the relocation, and
obtaining, by the MN, the new IP address through the DHCP process and obtaining the network prefix from the new IP address.

15. A system for updating a classifier, comprising:
a first device, adapted to acquire classifier information of a mobile node (MN) before a relocation of an access router (AR);
a second device, adapted to acquire classifier updating information of the MN after the relocation of the AR; and
a third device, adapted to update a portion of the classifier information with the classifier updating information for generating updated classifier information, wherein the portion of the classifier information is associated with the relocation of the AR.

16. A mobile communication system, comprising:
an access service network gate way (ASN-GW);
a base station (BS); and
a classifier management module adapted to save classifier information of a mobile node (MN), acquire classifier updating information of the MN after a relocation of an access router (AR), and update the classifier information of the MN with the classifier updating information.

17. The system according to claim 16, wherein the classifier management module is disposed in one of the ASN-GW and the BS.

18. The system according to claim 16, wherein
the BS is adapted to receive the updated classifier information delivered by the classifier management module in a target ASN-GW.

19. The system according to claim 16, wherein the MN is adapted to acquire the classifier updating information and send the classifier updating information to the BS, and the classifier management module in the BS updates the classifier information according to the classifier updating information from the MN.

20. A mobile node (MN), comprising:
a classifier information acquisition module; and
a classifier updating module, wherein
the classifier information acquisition module is adapted to acquire classifier updating information of the MN during a relocation of an MN's access router (AR) and notify the classifier updating information to the classifier updating module, and
the classifier updating module is adapted to update an uplink data classifier of the MN according to the classifier updating information.

21. The system according to claim 16, wherein the classifier management module in the BS is adapted to receive the classifier information before the relocation of the AR and the classifier updating information delivered by a target ASN-GW, and update the classifier information before the relocation of the AR with the classifier updating information.

22. The system according to claim 16, wherein the MN is adapted to acquire the classifier updating information and send the classifier updating information to the BS, the BS sends the classifier updating information to the classifier management module in the ASN-GW, and the ASN-GW updates the classifier.
